(19) United States
(12) Patent Application Publication
(10) Pub. No.: US 2016/0219368 A1
(43) Pub. Date: Jul. 28, 2016

(54) A LOUDSPEAKER TRANSDUCER ARRANGEMENT

(71) Applicant: BANG & OLUFSEN A/S, Struer (DK)

(72) Inventor: Lars Goller, Herning (DK)

(21) Appl. No.: 15/024,782

(22) PCT Filed: Sep. 10, 2014
(86) PCT No.: PCT/DK2014/050281

§ 371 Date: Mar. 24, 2016

(30) Foreign Application Priority Data
Sep. 26, 2013 (DK) PA 2013 00552

(51) Int. Cl. H04R 5/02; H04R 1/40; H04R 3/14

(52) U.S. Cl. CPC H04R 5/02; H04R 3/14; H04R 1/403

(57) ABSTRACT

A loudspeaker transducer arrangement in a loudspeaker system (where a user perceives the emitted sound substantially as the same regardless of relative listening position), where the loudspeaker transducer arrangement is characterized in that at least two sets of loudspeakers are provided, where each set includes at least two loudspeakers, and where the loudspeakers in each set emits sound in different directions away from an imaginary plane arranged between the two speakers and where each set of transducers include at least one high range transducer and at least one full range transducer, and where the high range transducer of the first set is arranged on the same side of the imaginary plane as the full range transducer of the second set.

### FIELD OF THE INVENTION

The present invention relates to a loudspeaker transducer arrangement in a loudspeaker system to obtain an omnidirectional emitting of sound, as perceived by a user.

### BACKGROUND OF THE INVENTION

When a loudspeaker is placed within an enclosed space the timbre of the loudspeaker as perceived by a listener is highly affected by the acoustical properties of the space this being a room or any enclosure.

U.S. Pat. No. 8,175,304 disclose a stereo loudspeaker system built into a single unit. By splitting, summing and filtering the stereo signal and distributing processed signals to midrange transducer units arranged for emitting sound in different directions, and relying on the bounce of sound from the environment (walls) a user will experience a substantially omni-directional stereo effect from the emitted sound. The necessity of filters, pre-amplifiers etc requires a relatively high power consumption by the device, and furthermore in order to obtain the substantially balanced and omni-directional stereo emission, the speaker units are required to be identical.

GB 1,351,842 describes an omni-directional speaker unit having a number of sides, where one or more transducers are arranged in each side for emitting sound substantially perpendicular to the respective sides. The transducers are arranged such that each transducer (or assembly of transducers) in each side will have a radiation pattern such that radiation patterns from adjacent sides overlap. In this manner a substantially omni-directional sound is perceived by a listener. Each side is designed to emit the full sound, and due to the variance in spreading patterns for low frequency and high frequency sounds as well as different absorption/reflection characteristics of walls in a room, sufficient transducer units shall be provided and at the same time each transducer unit shall be tuned to emit the correct intensity in order to achieve the perceived omni-directional sound experience.

Traditionally stand-alone loudspeaker systems include separate Left and Right channel transducers to represent the L and R stereo signals.

In smaller loudspeaker systems it may be an advantage for the user to perceive the sound emitted to be more omnidirectional without having the clear L/R separation of the emitted sound.

### OBJECT OF THE INVENTION

Thus an object of the invention is to obtain the omnidirectional behavior with simple means by having the loudspeaker transducers arranged symmetrically along a common axis and in two pairs each pair including at least two transducers.

### DESCRIPTION OF THE INVENTION

Embodiments including the invention as disclosed is very applicable in loudspeaker systems to be placed anywhere in a room, on a table or alike where the omnidirectional behavior is important for the user.

In a first embodiment of the invention a loudspeaker transducer arrangement is disclosed wherein a loudspeaker system (where a user perceives the emitted sound substantially as the same regardless of relative listening position), where the loudspeaker transducer arrangement is characterized in that at least two sets of loudspeakers are provided, where each set includes at least two loudspeakers, and where the loudspeakers in each set emits sound in different directions away from an imaginary plane arranged between the two speakers and where each set of transducers include at least one high range transducer and at least one full range transducer, and where the high range transducer of the first set is arranged on the same side of the imaginary plane as the full range transducer of the second set.

By arranging the loudspeakers in sets emitting sound in different directions the designated sound signal for for example one channel will be emitted in different directions due to the arrangement of the first loudspeaker in a set emitting in a first direction and the second speaker in the same set emitting in a different direction. Therefore the listener will perceive different sound pictures depending on the listening position, but due to this very simple arrangement a substantially omnidirectional sound is emitted from the arrangement by very simple means.

In a further advantageous embodiment the emitted sound is being perceived omnidirectional by a listener due to the sound emitted from:
a. The first loudspeaker in the first set and the second loudspeaker from the second set;
b. the second loudspeaker from the first set and the first loudspeaker from the second set;
c. the first and second loudspeaker from the first set;
d. the first and second loudspeaker from the second set.

In this manner the omnidirectional sound emission will be perceived by a user as more or less the same regardless of the listening position relative to the device. As each set comprises a high range transducer, i.e. emitting the sounds of higher frequencies and a low full range transducer, i.e. emitting sounds in the low and medium range frequencies, the combined effect of a set will be a full sound picture. As each set is split to emit sound in different directions from an imaginary plane, listeners on either side of this plane will hear the high range and full range transducer of different sets, whereas listeners positioned almost in the imaginary plane will hear the high range and full range transducers of the same set. In this manner the sound perceived by a listener will be substantially the same regardless of the listening position.

In a still further advantageous embodiment the loudspeaker transducer arrangement according to any previous claim where the loudspeaker transducer arrangement further includes at least one low range transducer. As the radiation pattern of low range transducers in itself is relatively omnidirectional, i.e. the lower frequencies have a much broader spreading angle, an arrangement including a single low range transducer will typically be able to emit the low range signal sufficiently broad such that a listener will not be able to determine the actual direction from which the sound is emitted.

In a still further advantageous embodiment the sets of loudspeakers are mounted in a three-dimensional enclosure, with a ground plane shaped in one of the geometrical forms of square, rectangle, hexagonal, octagonal, ellipse or circle.

Surprisingly, tests have indicated that as long as the loudspeakers are arranged on either side of an imaginary plane as described above, the perceived listening will be more or less the same regardless of the listener's orientation relative to the arrangement.

Further advantageous embodiments are elaborated in further dependent claims.

### DESCRIPTION OF THE DRAWING

In the following, preferred embodiments of the invention will be described with reference to the drawing wherein:

FIG. 1 illustrates the concept of the invention with the loudspeaker transducer arrangement as configured.

FIG. 2 illustrates how the emitted sound is perceived in all directions.

FIG. 3 illustrates how embodiments may have different geometrical shapes.

FIG. 4 illustrates isometric depictions of an embodiment of the invention.

### DETAILED DESCRIPTION OF THE INVENTION

In a first aspect the invention relates to:

A loudspeaker transducer arrangement in a loudspeaker system to obtain an omnidirectional emitting of sound from the system as perceived by a user.

And with a second aspect, a loudspeaker arrangement, where
each pair of transducers include at least one high range transducer and at least one full range transducer, and
a first pair of transducers are aligned along the front surface of an enclosure, and emitting sound primarily away from the front surface, and
a second pair of transducers are aligned along the back surface of an enclosure, and emitting sound primarily away from the back surface.

And with a third aspect of the invention is a loudspeaker arrangement where the sound is being perceived omnidirectionally caused by the sound beams generated from:
the pair of transducers including X1 and Y1, and
the pair of transducers including X2 and Y2, and
the pair of transducers including X1 and Y2, and
the pair of transducers including X2 and Y1.

In a preferred embodiment of the loudspeaker arrangement, the arrangement includes at least one low range transducer, e.g. a subwoofer.

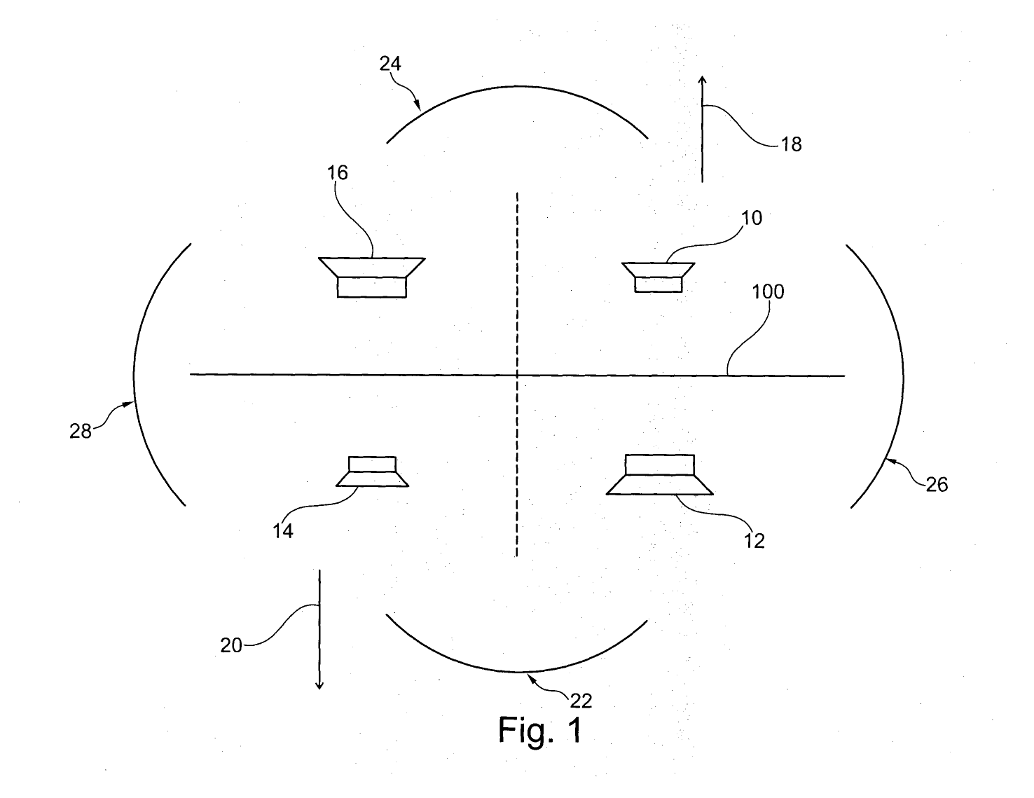

In FIG. 1 the invention is displayed with the main elements:
two or more full range transducers (X1, X2), to provide full range frequency sound waves.
two or more high range transducers (Y1,Y2), to provide high frequency sound waves.
the sound is emitted from the first pair of transducers (X1,Y1) primarily in a first direction.
the sound is emitted from the second pair of transducers (X2,Y2) primarily in a second direction.

The principle of the invention as illustrated in FIG. 1 depicts two sets of loudspeakers where a first set of loudspeakers includes a high range transducer 10 and a full range transducer 12 and the second set includes a high range transducer 14 and a full range transducer 16. Each loudspeaker in each set is arranged on opposite sides of an imaginary plane 100 such that the loudspeakers 10, 12 and 16, 14 will emit sound in different directions indicated by the arrows 18, 20.

Consequently, a listener standing in front of the loudspeakers 12, 14 will perceive the emitted sound as indicated by the arch 22. Likewise, a listener standing in front of the loudspeakers 10, 16 will perceive the sound as indicated by the arch 24. The perceived sound 22, 24 derives from speakers belonging to different sets, but will nevertheless due to the provision of both a high range and a full range transducer provide a full sound picture. A listener positioned in the axis of the imaginary plane 100 will perceive the sound as indicated by the arches 26, 28, i.e. sound from loudspeakers belonging to the same set. For illustrative purposes the arches 22, 24, 26, 28 are not overlapping, but it is clear that a listener positioned for example between the arches 22 and 26 will, depending on the exact position receive the sound from the full range speaker 12 and the high range speakers 14, 10 depending on which loudspeaker will have a dominating radiation pattern.

The sound system may operate with mono signals or L/R stereo as according to a specific product requirement.

In a preferred embodiment the transducer configuration is enabled to provide L/R stereo signal to the user.

Specifically for a smaller sound system this is very beneficial with the L/R stereo signal to obtain the omnidirectional feature by simple means, i.e. no advanced digital signal processing like filter/delay algorithms are required.

This is obtained by having the configuration:
full range transducer X1 and high range tweeter Y2 play the same channel e.g. Left.
full range transducer X2 and high range tweeter Y1 play the same channel e.g. Right.

There is no need for active filters, thus the power consumption is very low and the invention is very useful in portable wireless sound systems powered by batteries.

Even in a small physical embodiment the sound quality is acceptable. Up to approximately 10 kHz there is a 360 deg. radiation pattern. This will assure a good distribution of energy around the sound system at most frequencies.

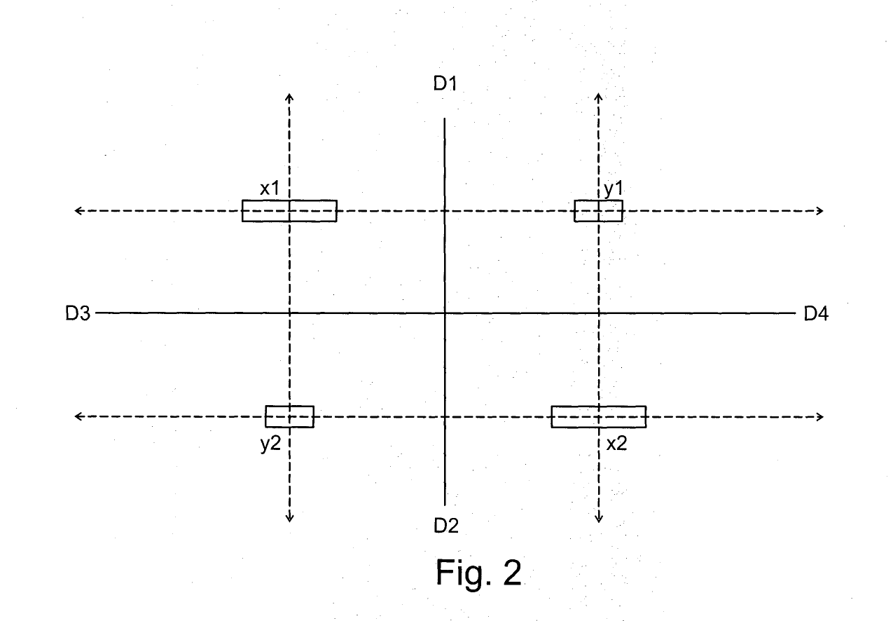

FIG. 2 illustrates where an L/R stereo sound signal will be perceived by the user in four directions (D1, D2, D3, D4), with the sound signal coming from:
transducers X1 and Y1, or
transducers X2 and Y2, or
transducers X1 and Y2, or
transducers X2 and Y1.

The perceived sound, as expired by the user, is as illustrated in FIG. 1.

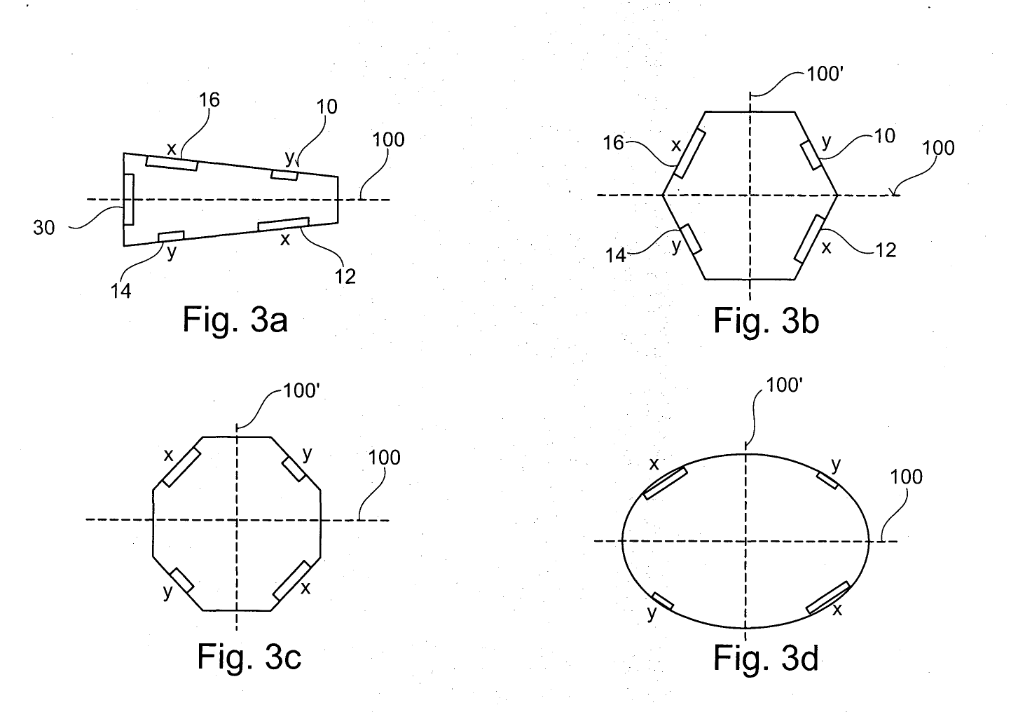

FIGS. 3a-d illustrate how alternative embodiments of the sound systems are applicable. Any geometrical form may be applied, in which an equal number of transducers can be mounted. This due to the fact that the transducers are configured in pairs of two.

With respect to FIGS. 3a-d the same reference numbers introduced in FIG. 1 will be applied to the figures. Consequently FIG. 3a illustrates a loudspeaker arrangement comprising two sets of loudspeakers arranged in a trapezoidally shaped housing. In addition to the high range and full range loudspeakers a further low range loudspeaker 30 is provided. As already elaborated above, the radiation pattern of low range speakers is such that even a listener positioned along the imaginary plane 100 opposite the position of the low range speaker 30 will be able to hear the low range sound emission in combination with the sound emitted from the speakers 10, 12.

In the FIGS. 3b-3Dd substantially symmetrical arrangements are illustrated, and consequently two imaginary planes 100, 100′ may be applied to the description of how the sound is emitted and how the sound is perceived by a listener. The configuration and perceived sound is completely analogue to the description above with reference to FIG. 1. In these embodiments, although each speaker has been indicated with a reference number the sets of speakers may be arranged about any of the imaginary 100, 100′ in order to achieve the effect of the present invention.

A low range transducer (Z) may expand the low frequency domain of the system, and can be embedded into the sound system without any specific requirement to the placement of the woofer unit.

In the preferred embodiment of the loudspeaker arrangement the pair of transducers is mounted into a 3-dimensional enclosure with a ground plane shaped in one of the geometrical forms square, rectangle, hexagonal, octagonal, ellipse or circle.

The invention is very applicable in small loudspeaker systems being standalone or being integrated into home appliances and/or in media systems.

By simple means the omnidirectional behavior is obtained with great benefits for the user.

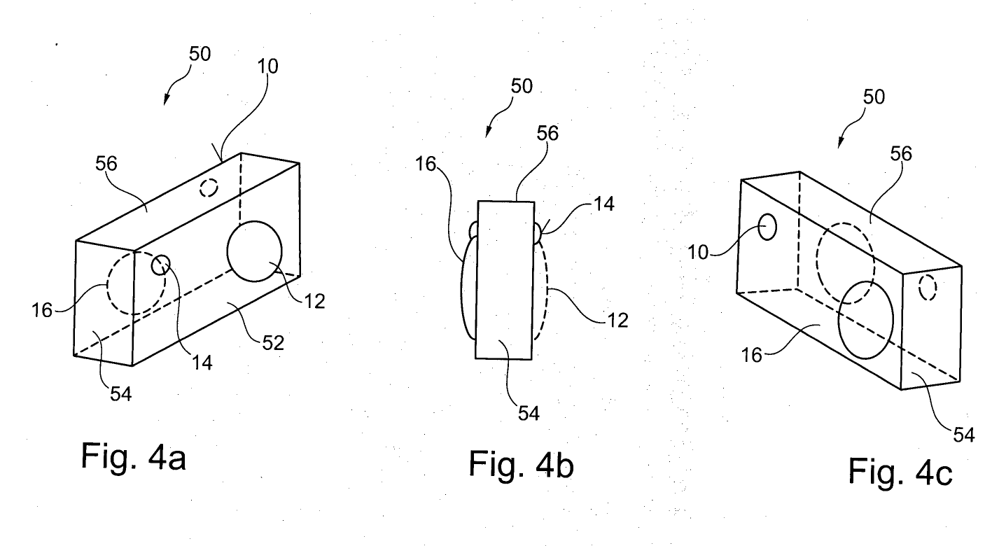

With reference to the device as schematically illustrated in FIG. 4a-4c the invention will be explained. In the figures illustrative isometric depictions of an embodiment of the invention is illustrated in the shape of a device 50 as seen from different listeners positions relative to the device 50. In FIG. 4a the first side 52 of the device is visible to a listener, and consequently the transducers 14 and 12 will emit the dominating sound as perceived by the listener. For illustrative purposes the other two transducers 10, 16 are illustrated in dashed lines. As the device is rotated relative to the user such that the end face 54 of the device will be in a position as illustrated in FIG. 4b the perceived dominating sound to the user will be emitted by the transducers 16 and 14. The sound emitted by 12 (illustrated in dashed lines in FIG. 4b) will have faded from the user's point of listening. The overall listening and thereby the overall perceived sound will remain substantially constant to the listener, since, as the device is rotated (or the user moves relative to the device) the sound from the full range transducer 12 will fade at high frequencies but be compensated by the increasing high frequency level of the driver 10. At the same time the sound from the other full range transducer 16 will increase and the HF transducer 14 decrease, thereby balancing the omnidirectional sound emission by the device 50. As the device 50 is further rotated (or the user's position has shifted further) as illustrated in FIG. 4c the transducers 16 and 10 will produce the main part of the perceived sound.

Correspondingly, the perceived sound would follow an analog perception should the listening position (or the device) be changed such that the position would transverse the upper side 56 or any other side of the device.

For illustrative purposes the transducers are depicted as being concave out of the device surfaces as well as being arranged in distinct positions and having relative size relationships, but in practice any size, design etc. will work as long as the underlying inventive principle is applied to the transducer arrangement.

1. A loudspeaker transducer arrangement in a loudspeaker system where a user perceives the emitted sound substantially as the same regardless of the listener's relative listening position, wherein the loudspeaker transducer arrangement comprises at least two sets of loudspeakers, where each set of loudspeakers includes at least two loudspeakers, and where the loudspeakers in each set emits sound in different directions away from an imaginary plane arranged between said two loudspeakers and where each set of loudspeakers includes at least one high range transducer and at least one full range transducer, and where the high range transducer of a first set is arranged on the same side of the imaginary plane as the full range transducer of the second set.

2. The loudspeaker transducer arrangement according to claim 1 where the emitted sound is being perceived omnidirectional by a listener due to the sound emitted from:
a. The first loudspeaker in the first set and the second loudspeaker from the second set;
b. the second loudspeaker from the first set and the first loudspeaker from the second set;
c. the first and second loudspeaker from the first set;
d. the first and second loudspeaker from the second set.

3. The loudspeaker transducer arrangement according to claim 1 where the loudspeaker transducer arrangement further includes at least one low range transducer.

4. The loudspeaker transducer arrangement according to claim 1, where the sets of loudspeakers are mounted in a three-dimensional enclosure, with a ground plane shaped in one of the geometrical forms of square, rectangle, hexagonal, octagonal, ellipse or circle.

5. The loudspeaker transducer arrangement according to claim 1, wherein the loudspeakers are arranged in a housing, said housing having at least two sides and where a loudspeaker from each set is arranged in each side.

6. The loudspeaker transducer arrangement according to claim 5 wherein at least the high range transducers are arranged adjacent side limitations of the sides of said housing.
